(19) United States
(12) Patent Application Publication
(10) Pub. No.: US 2006/0043645 A1
(43) Pub. Date: Mar. 2, 2006

(54) Vented mold and method

(76) Inventors: David D. Goettsch, Shelby Township, MI (US); Jerry Allen Barendreght, Leonard, MI (US)

Correspondence Address: CHARLES H. ELLERBROCK;General Motors Corporation, Legal Staff, Mail Code 482-C23-B21, P.O. Box 300, Detroit, MI, 48265-3000, US

(21) Appl. No.: 10/933,482

(22) Filed: Aug. 30, 2004

(51) Int. Cl. B23K 26/36; B29C 33/40

(52) U.S. Cl. 264/400; 249/141; 264/162

(57) ABSTRACT

Vented mold having a molding cavity defined by a wall that is too thick for suitably laser-drilling small holes therethrough. The wall has a front-face confronting the molding cavity, and a back-face opposite the front-face. The backface is drilled to a depth less than the thickness of the wall to provide a well in the back-face that has a bottom which is a thin portion of the wall. The thin portion of the wall has a thickness suitable for laser-drilling, and is laser-drilled with a plurality of vent holes less than 0.36 mm. in diameter.

### TECHNICAL FIELD

This invention relates to a mold for shaping substances introduced therein, and more particularly to a vented such mold, and method of making same.

### BACKGROUND OF THE INVENTION

Molds are hollow tools having two or more moving and fixed portions that, when closed on each other, define a molding cavity for receiving and shaping substances (e.g. molten metal, plastic etc.) injected, poured or otherwise introduced into the cavity. Some molds must be vented to achieve optimal filling of the molding cavity with the substance being molded, or to allow for treatment of that substance while it is in the mold. In the foundry industry for example, sand cores are made by blowing binder-containing sand into a mold, and subsequently thermally or chemically curing the binder. The vehicle (e.g. air) used to carry the sand into the mold must be allowed to readily escape from the mold cavity without carrying any of the core sand with it. Moreover, if the binder is to be chemically cured, the curing gas (e.g. CO₂) must enter the entirety of the mold cavity so as to contact all of the binder therein. To accomplish this result, the mold cavity must be vented in numerous places, some of which are difficult to access using conventional venting techniques (e.g. strategically placed vent plugs). Moreover, the foundry industry also uses vented molds to shape fugitive patterns used in the so-called “Lost Foam” process. In this process, a pattern molded from expanded polystyrene (EPS) foam and coated with a refractory is submerged in a bed of loose sand to form a molding cavity in the sand, and molten metal is poured into the cavity to pyrolize and displace the EPS pattern therein. The EPS foam patterns are made by blowing (e.g. in air) partially expanded EPS beads into a vented mold, and thereafter, introducing steam throughout the cavity to complete the expansion of the EPS beads. Vents in the cavity readily allow the air to escape during blowing without carrying any of the EPS beads out with it, and are thereafter used to admit the steam into the mold cavity. Heretofore, discrete, hollow, slotted vent plugs were manufactured independently of the mold, and then manually inserted into holes drilled in to the mold wall defining the molding cavity. Thereafter, the molding surface was machined to insure that the vent plugs were flush with the molding surface of the molding cavity. The process was time consuming and expensive.

Effective venting, without loss of the substance being molded, requires that the vents comprise very small (i.e. less than about 0.36 mm) vent holes. Such small holes are very difficult, and costly, to make using conventional hard-bit, rotary drilling techniques, owing to high labor and tool wear/breakage costs. Laser-drilling eliminates theses drawbacks, but has problems of its own. In this regard, when used with molds having wall thicknesses sufficient for mold strength and durability (≧ca. 10 mm for aluminum molds), laser-drilled vent holes have excessive taper, and are surrounded by untoward amounts of offal (solidified melt generated by the laser drilling) where the holes enter and exit the wall (i.e. at the mouths of the vent holes).

### SUMMARY OF THE INVENTION

The present invention is directed to a vented mold having very small (i.e. less than about 0.36 mm), laser-drilled vent holes (herein a.k.a. laserbores), and a method of making same.

Moldwise, the present invention contemplates a vented mold having a molding cavity defined in part by a wall that has a front-face confronting the cavity, a back-face opposite the front-face, and a first thickness (i.e. between said front-face and said back-face) that is unsuitable (i.e. too thick) for laser-drilling vent holes less than about 0.36 mm in diameter therethrough. In accordance with the present invention, a well is formed (e.g. drilled) in the back-face of the wall. The bottom of the well comprises a thin portion of the cavity-defining wall having a thickness that is less then the first thickness and is suitable for laser-drilling the vent holes. The thin portion of the wall at the bottom of the well will preferably be less than about 2 mm thick. A plurality of laser-bores through the thin portion of the wall form the vent holes.

Methodwise, the present invention contemplates venting a mold having a molding cavity defined by a wall which, in turn, has a front-face confronting the molding cavity, a back-face opposite the front-face, and a first thickness between the front-face and the back-face that is unsuitable for laser-drilling vent holes less than about 0.36 mm in diameter therethrough. In accordance with the method of the present invention, the back-face of the wall is drilled to a depth less than the first thickness so as to provide a well in the back-face that has a bottom comprising a thin portion of the wall, which thin portion has a second thickness less then the first thickness of the wall and suitable for laser-drilling the vent holes. Thereafter, a plurality of the vent holes are laser-drilled through the thin portion of the wall. Offal from the laser-drilling is deposited on the front-face around the vent holes during drilling, and is subsequently removed. Offal removal may be effected by dressing (e.g. buffing) the front-face, or blasting it with a pressurized fluid (e.g. air or water), with or without entrained solids (e.g. pumice or fine sand). The same array of lasers that are jigged to drill the vent holes may later be used to laser-clean the vent holes should they become clogged in use.

### BRIEF DESCRIPTION OF THE DRAWINGS

FIG. 1 is a plan view of the back-face of a mold half made in accordance with the present invention, and viewed in the direction 1-1 of FIG. 2;

FIG. 2 is section view in the direction 2-2 of FIG. 1;

FIG. 3 is a section view in the direction 3-3 of FIG. 1;

FIG. 4 is a view in the direction 4-4 of FIG. 2; and

FIG. 5 is an enlargement of the wall 5 taken at the site shown (i.e. encircled) in FIG. 2.

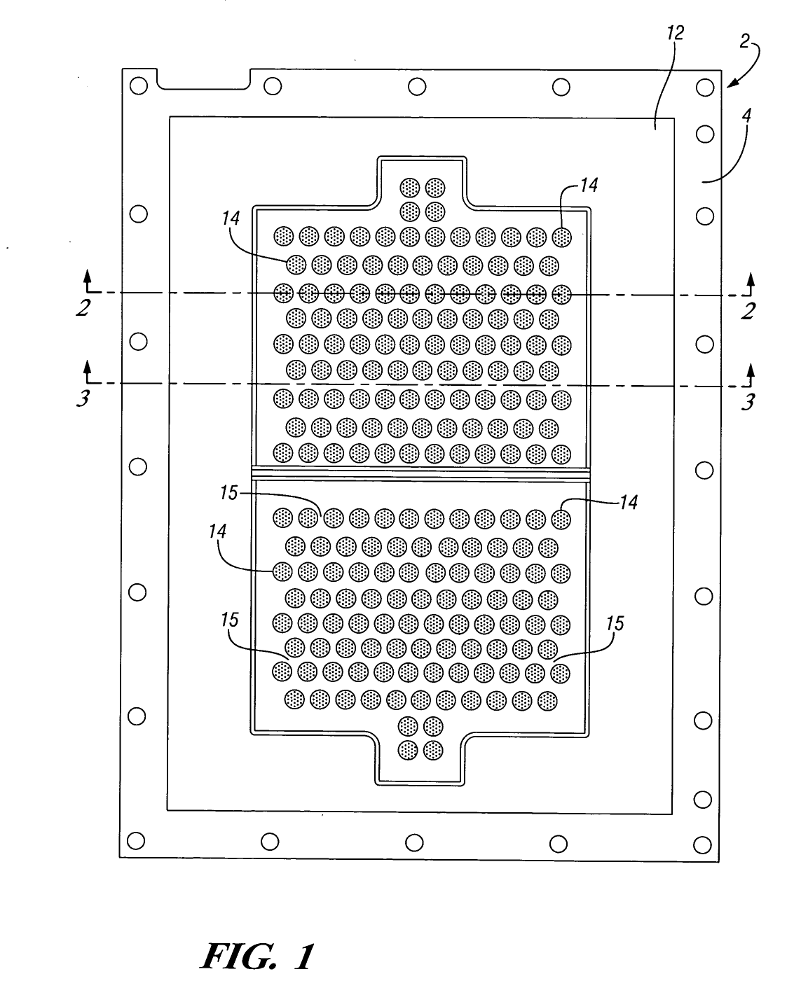

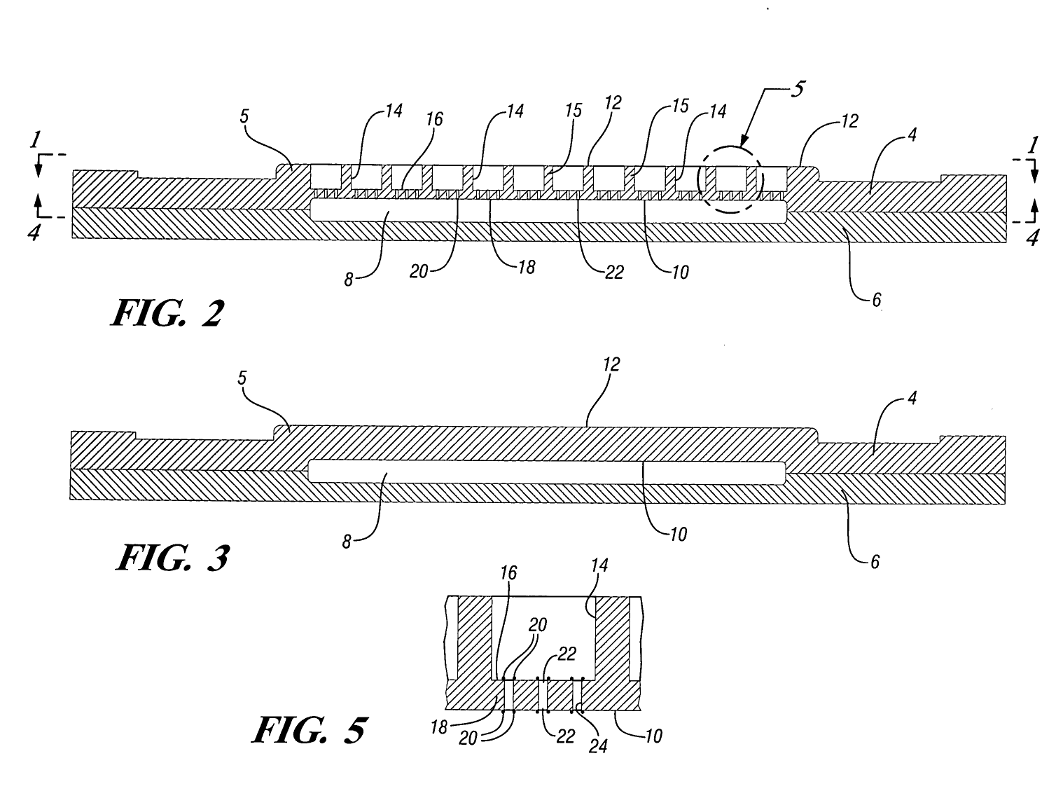

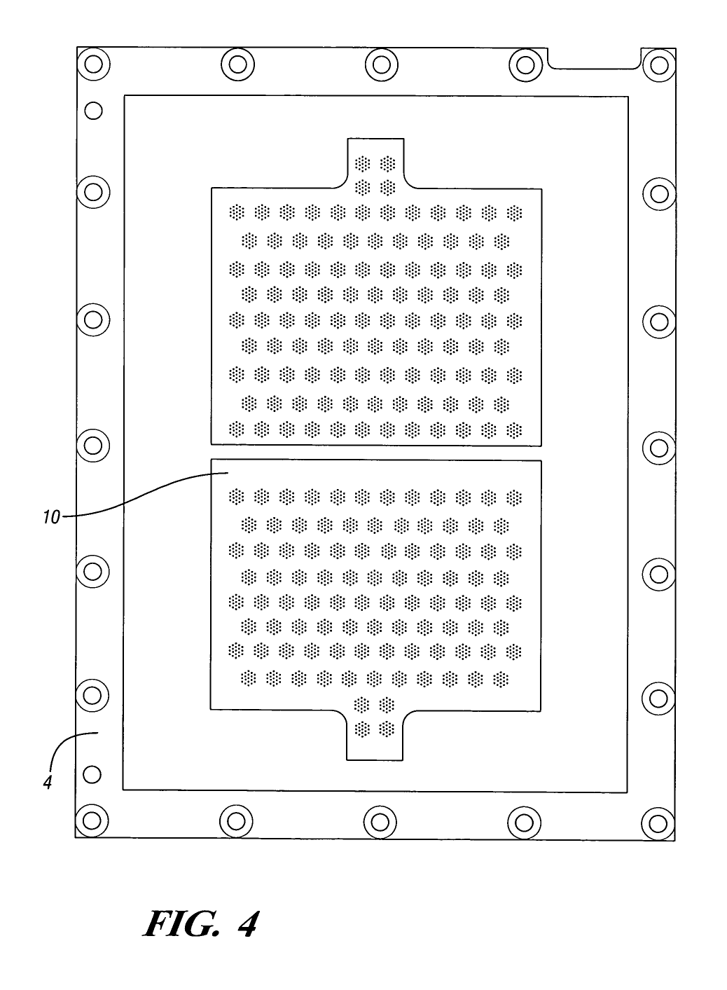

### DETAILED DESCRIPTION OF ONE EMBODIMENT

The several figures depict a vented test mold 2 used to evaluate the invention. The mold 2 has a first mold half 4 and a second mold half 6, together forming a molding cavity 8 therebetween for molding EPS foam panels. The first mold half 4 comprises a wall 5 having a front-face 10 confronting the mold cavity 8, and a back-face 12 opposite the front-face 10. The mold halves 4 and 6 each have a first thickness (i.e. between the front and back faces) sufficient to provide the mold 2 with strength and durability, which thickness is typically at least about 1 cm for molds made from aluminum. Unfortunately, 1 cm thick mold halves are too thick for effective laser drilling, since they produce unduly tapered holes and generate too much offal (i.e. melt from the laser-drilling) that accumulates and solidifies around the mouths of the laserbores (i.e. the laser-drilled holes) where the laser beam enters and exits the wall.

In accordance with the present invention, the back-face 12 of the mold half 4 is drilled at numerous locations adjacent the mold cavity 8 to provide a plurality of wells 14 each having a depth less than the first thickness of the mold half 12. The ribs of metal 15 remaining between the wells 14 interconnect with each other and provide a strengthening/reinforcing honeycomb structure that supports the wall 5 in the regions of the wells 14. The wells 14 have bottoms 16 formed from thinner portions 18 of the wall 5. The thinner wall portions 18 are sufficiently thin (i.e. less than about 2 mm) that laser-drilling thereof can be done without building up untoward amounts of solidified offal 20 around the mouths 22 of the laserbores/vent holes 24. The thinner portions 18 of the wall 5 are laser-drilled at diameters less than about 0.36 mm, and such that only the ends/mouths 22 of the laserbores appear on the front-face 10. Following laser-drilling, solidified offal 20 (see FIG. 5) from the laser-drilling is removed from the front-face 10 as by dressing (e.g. buffing) or blasting the front-face 10 with a fluid (i.e. gas or liquid) under pressure (with or without an entrained solid such as pumice or fine sand) to provide the front-face with a smooth surface.

While the invention has been described in terms of certain specific embodiments thereof it is not intended to be limited thereto, but rather only to the extent set forth hereafter in the claims which follow.

1. Method of venting a mold having a wall defining a molding cavity, said wall having (i) a front-face confronting said cavity, (ii) a back-face opposite said front-face, and (iii) a first thickness between said front-face and said back-face that is unsuitable for laser-drilling vent holes less than about 0.36 mm in diameter therethrough, comprising the steps of: drilling said wall, through said back-face, to a depth less than said first thickness to provide a well in said back-face having a bottom comprising a portion of said wall, said portion having a second thickness less then said first thickness and suitable for laser-drilling said vent holes; laser-drilling a plurality of said vent holes through said second portion and depositing offal from said laser-drilling on said front-face around said vent holes; and (c) removing said offal from around said vent holes.

2. Method according to claim 1 including the step of dressing said front-face after said laser-drilling.

3. Method according to claim 2 including buffing said frot-face to remove said offal.

4. Method according to claim 1 including the step of blasting said front-face with a pressurized fluid to remove said offal.

5. Method according to claim 4 wherein said fluid contains entrained solid particles.

6. Vented mold comprising (a) a wall defining a molding cavity, said wall having a front-face confronting said cavity, a back-face opposite said front-face, and a first thickness between said front-face and said back-face that is unsuitable for laser-drilling vent holes less than about 0.36 mm in diameter therethrough, (b) a well in said back-face having a bottom comprising a thin portion of said wall having a second thickness less then said first thickness and suitable for laser-drilling said vent holes, and (c) a plurality of laser-bores through said thin portion and forming said vent holes.

7. A vented mold according to claim 6 wherein said second thickness is less than about 2 mm.

8. A vented mold according to claim 6 wherein said well has a diameter of about 1 centimeter.
